(19) United States
(12) Patent Application Publication
(10) Pub. No.: US 2004/0257280 A1
(43) Pub. Date: Dec. 23, 2004

(54) Antenna device

(76) Inventor: Junichi Noro, Akita-Gun (JP)

Correspondence Address: J.C. Patents, Suite 250, 4 Venture, Irvine, CA, 92618, US

(21) Appl. No.: 10/769,597

(22) Filed: Jan. 30, 2004

(30) Foreign Application Priority Data
Jun. 17, 2003 (JP) 2003-172544

(51) Int. Cl. H01Q 1/42

(52) U.S. Cl. 343/700 MS; 343/872

(57) ABSTRACT

An antenna device is provided for receiving satellite signals with a high sensitivity in the zenith direction, and the directivity of the antenna device is directed in the zenith direction. In the antenna device for receiving satellite signals, an antenna element is accommodated in a cover member. A metal plate is arranged on an inner surface of a ceiling portion of the cover member. The directivity of the antenna element can be directed towards the direction where the metal plate is arranged. The directivity of the antenna element can be directed in the zenith direction by arranging the metal plate on the inner surface of the ceiling portion of a case (the cover member) in which the antenna element is accommodated.

### CROSS-REFERENCE TO RELATED APPLICATION

This application claims the priority benefit of Japanese application serial no. 2003-172544, filed on Jun. 17, 2003.

### BACKGROUND OF THE INVENTION

1. Field of the Invention

This invention relates in general to an antenna device for receiving radio wave from an artificial satellite. More specifically, the present invention relates to a technical improvement for the directivity of the antenna device.

2. Description of Related Art

Presently, a system to instruct and guide a course, etc. for an automobile driver, namely, a car navigation system, has become widely popular. In such a car navigation system, the current location is identified according to the car speed and the driving distance, etc. On the other hand, in order to increase a position accuracy, radio waves emitted from a GPS (Global Positioning System) satellite are received by a GPS antenna, and the current location can be identified by position information acquired from the received radio waves.

In America recently, providing a digital radio broadcast, etc. using the radio waves emitted from an artificial satellite has also been advanced. In a digital radio receiving system for receiving such digital radio broadcast, the antenna is also required to receive the radio waves emitted from the satellite, that is, a receiving antenna for satellite radio is used. For example, a patch antenna is used as a GPS receiving antenna or a satellite radio-receiving antenna. For the patch antenna, a ground electrode formed by a conductive material is disposed on one principal plane of a ceramic substrate that serves as an insulating member, and a receiving electrode is disposed on the other principal plane of the ceramic substrate. Received signals are output to an external circuit from a power pin. Japanese Laid Open Publication No. H10-276028 has disclosed this technology.

The aforementioned GPS receiving antenna or the satellite radio receiving antenna is usually mounted on the car roof, etc. in a manner that an antenna unit (such as a patch antenna) is installed on an antenna substrate and being covered in a cover member.

At this time, the antenna has to be set according to the artificial satellite in a manner that the receiving sensitivity of the antenna unit is mainly spread upwards. The radio waves emitted from the artificial satellite have a feature of a very high directivity since a high frequency band is used. Therefore, for the antenna device for receiving such radio waves, there is a demand that the sensibility to the zenith direction is as high as possible.

### SUMMARY OF THE INVENTION

According to the foregoing description, an object of the present invention is to provide an antenna device for receiving satellite signals with a high receiving sensitivity in the zenith direction. This antenna device can improve the directivity of the antenna device in the zenith direction.

In accordance with the above object, the inventor of the present invention discovers that the arrangement of a metal plate can effectively improve the directivity of the antenna device. In a preferred embodiment of the present invention provides an antenna device in which an antenna element is accommodated in a cover member. The antenna device is characterized in that a metal plate is arranged on an inner surface of a ceiling portion of the cover member.

In a preferred embodiment of the present invention, the metal plate is arranged on an inner surface of the ceiling portion of the cover member. According to various experiments performed by the present inventor on the effect of the metal plate, it was found that the directivity of the antenna element can be directed towards the direction where the metal plate is arranged. Therefore, the directivity of the antenna element can be turned in the zenith direction by properly arranging the metal plate on the inner surface of the ceiling portion of the cover member.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 is a schematic cross-sectional view showing a structure of an antenna device according to the present invention.

FIG. 2 is a perspective view of an exemplary patch antenna as an antenna element according to the present invention.

FIG. 3 is a schematic plan view showing the inner surface of a cover member according to the present invention.

FIG. 4A shows a directivity characteristic of a patch antenna without the metal plate arrangement.

FIG. 4B shows a directivity characteristic of a patch antenna in a case that the metal plate 4 is arranged on an inner surface of the ceiling portion of the cover member.

### DESCRIPTION OF THE PREFERRED EMBODIMENT

The antenna device according to one embodiment of the present invention is described in detail with reference of attached drawings.

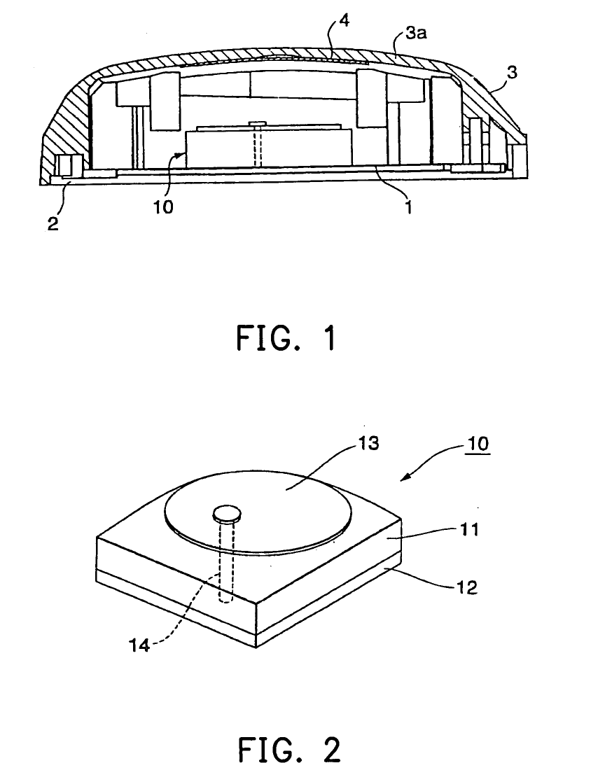

FIG. 1 shows a schematic cross-sectional view of a structure of the antenna device according to one preferred embodiment of the present invention. As shown in FIG. 1, a printed board 1 on which an antenna element 10 for receiving radio waves from an artificial satellite is packaged thereon is used as an antenna unit. The printed board 1 is set on a base plate 2. The printed board 1 is sealed in a dome-shaped cover member 3.

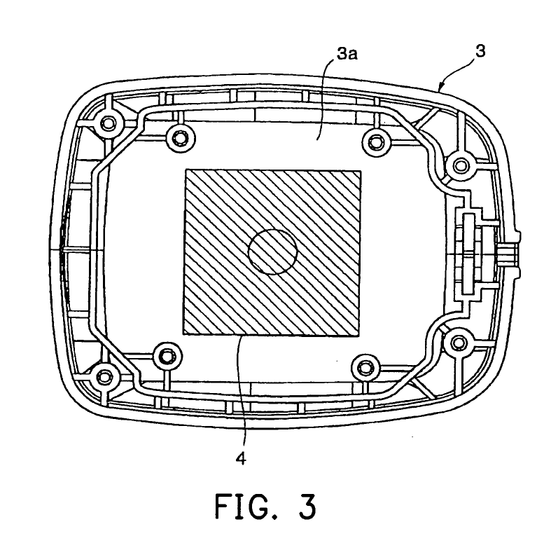

For example, a patch antenna can be used as the antenna element 10. FIG. 2 shows a perspective view of an exemplary patch antenna. As shown in FIG. 2, a ground electrode 12 is formed on one principal plane of a ceramic substrate 11 that serves as an insulating member, and a receiving electrode 13 is formed on another principle plane of the ceramic substrate 11. Received signals are output to an external circuit via a power pin 14. However, the aforementioned configuration is not used to limit the scope of the present invention. For example, an antenna element where a reversed F-shape antenna is arranged in a space formed between a first metal plate and a second metal plate can also be used.

For example, for mounting the above antenna unit on an automobile roof, the antenna unit having the antenna element 10 is installed on the automobile roof in a manner that the antenna unit is accommodated within a space sealed by the base plate 2 and the cover member 3, so that rainwater does not enter the antenna unit. Therefore, the base plate 2 and the cover member 3 function to serve as a case for covering and sealing the antenna unit. In addition, a rubber packing, etc. is disposed between the base plate 2 and the cover member 3 to render the whole assembly as a waterproof structure.

In the prior art, the cover member 3 is usually made of plastic, for example, is a dome-shaped forming body, and serves as a case only for covering the antenna element 10. However, the present invention utilizes the cover member 3 to improve the directivity of the antenna element 10 in the zenith direction by arranging a metal plate 4 on an inner surface of the ceiling portion of the cover member 3.

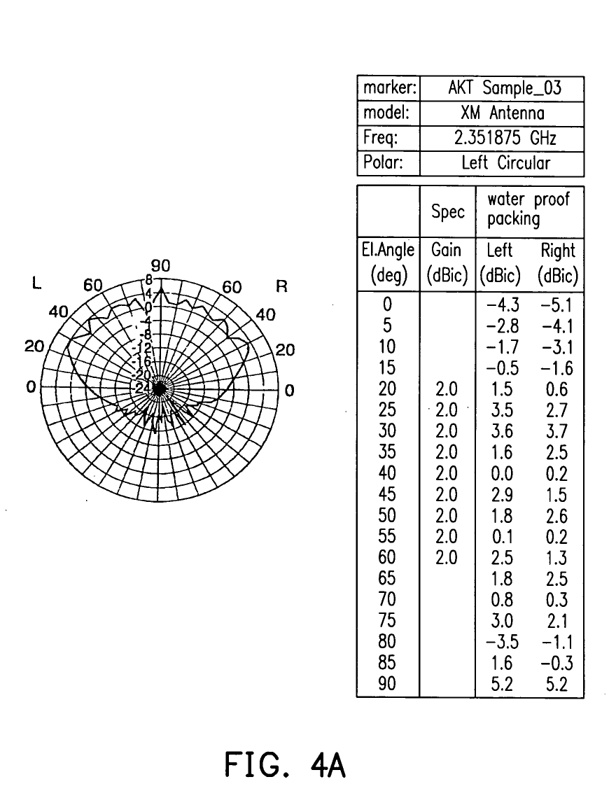

The cover member 3 is arranged to cover the antenna element 10 and has a ceiling portion 3a that is opposite to the receiving electrode 13. As shown in FIG. 3, the metal plate 4 is arranged on the ceiling portion 3a. The metal plate 4 can use any material; for example, an aluminum plate can be used. In addition, the metal plate 4 can be simply formed by adhering a metal tape on the ceiling portion 3a, for example.

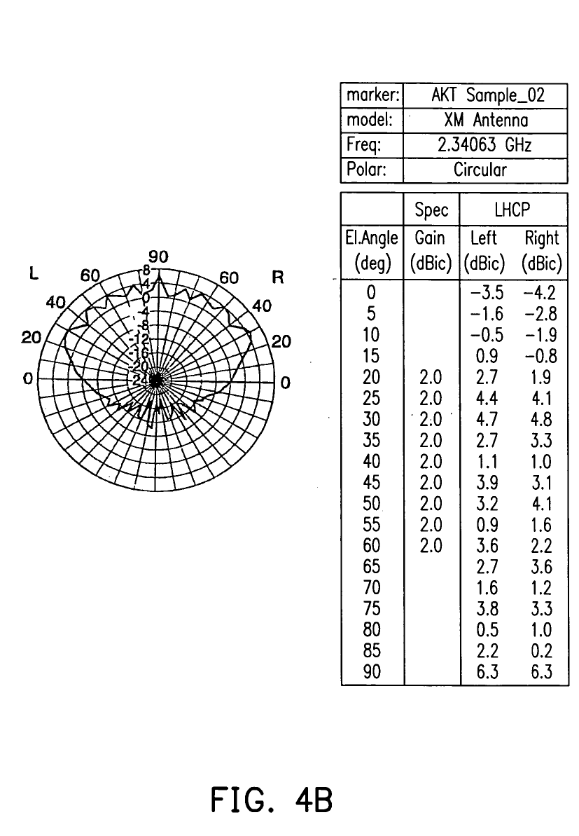

FIG. 4A shows a directivity characteristic of a patch antenna without forming the metal plate, and FIG. 4B shows a directivity characteristic of a patch antenna including the metal plate 4 arranged on the inner surface of the ceiling portion 3a of the cover member 3.

By comparing the results on the directivity characteristics between the antenna units shown in FIGS. 4A and 4B, it can be obviously inferred that by arranging the metal plate 4 on the inner surface of the ceiling portion 3a of the cover member 3, the receiving sensitivity in the 0° to 90° degrees, i.e., atop the receiving plane, can be substantially improved.

As described above, according to the antenna device of the present invention, since a metal plate is arranged on the inner surface of the ceiling portion of the cover member, the directivity of the antenna device can be directed to the zenith direction. Therefore, an antenna device with a high receiving sensitivity in the zenith direction can be provided.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

1. An antenna device, comprising:
a cover member;
an antenna element accommodated in the cover member; and
a metal plate, arranged on an inner surface of a ceiling portion of the cover member.

2. The antenna device of claim 1, wherein the metal plate is a metal tape adhered to the inner surface of the ceiling portion of the cover member.

3. The antenna device of claim 1, wherein the antenna element is a patch antenna.

4. The antenna device of claim 1, wherein the metal plate is disposed at a position opposite to a receiving surface of the antenna element.

5. The antenna device of claim 2, wherein the metal plate is disposed at a position opposite to a receiving surface of the antenna element.

6. The antenna device of any one of claim 3, wherein the metal plate is disposed at a position opposite to a receiving surface of the antenna element.
